(19) United States
(12) Patent Application Publication
(10) Pub. No.: US 2012/0138108 A1
(43) Pub. Date: Jun. 7, 2012

(54) DISHWASHER, IN PARTICULAR DOMESTIC DISHWASHER, HAVING A DOOR LOCK, AND ASSOCIATED DOOR LOCK

(75) Inventors: Cesar Astiz Montoya, Noveleta (Estella) (ES); Michael Hartmann, Hochstadt (DE); Helmut Jerg, Giengen (DE); Christian Mesarosch, Augsburg (DE); Maria Itziar Pascual Iturbe, Estella (ES)

(73) Assignee: BSH BOSCH UND SIEMENS HAUSGERÄTE GMBH, Munich (DE)

(21) Appl. No.: 13/389,444

(22) PCT Filed: Aug. 10, 2010
(86) PCT No.: PCT/EP10/61576

§ 371 Date: Feb. 8, 2012

(30) Foreign Application Priority Data
Aug. 25, 2009 (EP) 09382157.7

(51) Int. Cl. A47L 15/42; E05C 1/08; E05C 19/00

(52) U.S. Cl. 134/113; 292/2; 292/137

(57) ABSTRACT

A dishwasher, in particular domestic dishwasher, includes a washing compartment having a loading opening which can be closed by a door. A determination device is provided for determining a position of the door and includes a signal transmitter and a signal receiver, with the signal transmitter or signal receiver being arranged in and/or on a movably mounted element and determining the position of the door, in particular the closed end position of the door.

The invention relates to a dishwasher, in particular domestic dishwasher, having a washing compartment, of which the loading opening can be closed by a door, and having a determination device for determining the position of the door, said determination device comprising a signal transmitter and a signal receiver.

For safety reasons, a dishwasher, in particular domestic dishwasher, often has, for determining the position of the door, a determination device comprising a signal transmitter and a signal receiver. This determination device serves in particular to check whether the door of the dishwasher is properly closed in its closed end position. Such a dishwasher can normally not be put into operation, i.e. a selected dishwashing program is not started by the control device of the dishwasher in particular until the determination device of said dishwasher has determined that the door is properly closed. In practice, however, production tolerances, e.g. with regard to the dimensions of the loading opening of the dishwasher, play in the bearings of the door hinge, etc., in particular can render it difficult to detect the closed end position of the door correctly. For example, it can happen that the determination device identifies an open position of the door incorrectly as a closed end position, even though the door has not yet fully reached its closed end position in its particular closing process. The dishwasher program selected in this case would then be started by the control device of the dishwasher, even though a gap in the door were still open and the door not yet tightly closed. Washing-liquor liquid could consequently be sprayed out from the interior of the washing compartment of the dishwasher during the wash cycle of the dishwasher, which is undesirable and, in particular on safety grounds, inadmissible.

The object of the invention is to provide a dishwasher, in particular a domestic dishwasher, having an improved determination device for determining the respective position, in particular the closed end position, of the door of said dishwasher.

This object is achieved in a dishwasher, in particular domestic dishwasher, of the type referred to in the introduction, in that a movably mounted element is provided, in and/or on which the signal transmitter or the signal receiver of the determination device for determining the position of the door, in particular the closed end position of said door, is arranged.

Such a movably mounted element for the signal transmitter or signal receiver of the determination device makes it possible in a simple manner for the respective position, in particular closed end position of the door during the closing process of said door, and/or the leaving of the closed end position of the door during the respective opening process of said door, to be determined and/or detected in an improved manner by the control device of the dishwasher according to the invention.

The inventive arrangement either of the signal transmitter or of the signal receiver of the device in and/or on the movably mounted element for determining the position of the door makes it in particular possible, according to an advantageous development of the invention, for example during the closing of the door, for signal transmitter and signal receiver to be moved away from one another again independently of the closing movement of the door shortly before the closed end position of the door is reached, and to be moved toward one another abruptly only when the closed end position of the door is reached. The arrangement either of the signal transmitter or of the signal receiver in and/or on the movably mounted element thus makes it possible in particular for the signal transmitter and signal receiver which are moving toward one another during the respective closing process of the door to be moved away from one another again by means of an opposing movement provided specifically by the movably mounted element shortly before they reach their end positions in the closed end position of the door so that subsequently, when the closed end position of the door is reached, an abrupt, i.e. sudden, jump below a critical distance between the signal transmitter and the signal receiver with an accompanying steep rise in the received signal level of the signal receiver is then possible due to abrupt movement of signal transmitter and signal receiver toward one another by means of the movably mounted element. Only when this defined critical distance between the signal transmitter and the signal receiver is fallen below does the determination device determine that the closed end position of the door has been reached.

Due to the fact that either the signal transmitter or the signal receiver attains with the aid of the movably mounted element at least an additional degree of freedom, when the closed end position of the door is reached, a more defined approach, in particular a faster approach, of the signal transmitter toward the signal receiver (and vice versa) can be achieved than in the case of a merely stationary, fixed arrangement of signal transmitter and signal receiver on the door and/or the washing compartment of the dishwasher, which arrangement would lead, during the closing of the door, merely to a continuous approach of signal transmitter and signal receiver and thus to a continuous curve of the receive level of the signal receiver. In contrast, with the aid of the additional movably mounted element, the signal transmitter and the signal receiver can be moved toward one another jerkily, which is accompanied by a sudden change in the received signal level of the signal receiver when the door reaches a certain door position, in particular its closed end position, in which it seals off the loading opening of the washing compartment in a liquid-tight and/or steam-tight manner. This sudden significant change in the curve of the received signal level of the signal receiver, viewed over the duration of the door-closing process, can clearly be detected by the control device of the dishwasher as a specific event, so that the point in time at which the door actually reaches its closed end position is detectable by said control device in an improved manner compared with a continuous convergence of signal transmitter and signal receiver and accompanying continuous received signal level curve.

Conversely, the leaving of the closed end position of the door can also in an advantageous manner clearly be detected and/or registered by the control device of the dishwasher each time the door is opened, in that, due to the inventive arrangement of the signal transmitter and of the signal receiver in and/or on the movably mounted element, the signal transmitter and the signal receiver can be moved away from one another abruptly, largely independently of the opening movement of the door, when said door leaves its closed end position. With this abrupt, sudden separation of signal transmitter and signal receiver from one another, the received signal level of the signal receiver falls abruptly, which can serve for the control device as a specific significant detection criterion indicating that the door is leaving its closed end position.

According to an advantageous development of the invention, a closing piston or closing block of a door lock is provided as a movably mounted element. The movably mounted element is in particular an integral part of a door-lock housing. In this way, the signal transmitter or signal receiver of the determination device according to the invention can be accommodated, in particular integrated, in the components of the door lock. The closing piston of the door-lock housing consequently has a dual function: it serves firstly as a mechanical locking or closing element for fixing and/or retaining, in particular for arresting, the door in its closed end position on the washing compartment. Secondly, it comprises one of the two main components, i.e. signal transmitter or signal receiver, of the position-determination device according to the invention. This ensures that the signal transmitter or signal receiver, which is mounted in and/or on the closing piston, also makes the movements of said closing piston. If, in the closed end position of the door, the closing piston embodied advantageously in such a manner, of a door-lock housing which is provided for example on the front edge region, in particular centrally on the front upper edge section, of the washing compartment, is introduced into and engages with a corresponding counterpart, such as e.g. a cavity, in particular a closing trough, which is provided, positionally corresponding to the door-lock housing, in the central region of the upper edge section and/or upper cheek section of the door, in particular the door frame element of said door or the inner door of said door, then the closing movement of the piston is largely independent, i.e. decoupled, from the pivoted movement of the door, in particular from the play of its bearings, or other tolerances, e.g. of the washing compartment. It can always be brought to a defined closed position or arrested position such that e.g. the signal transmitter mounted on and/or in it can always be brought to a unique positional relationship relative to its counterpart, a signal receiver, in and/or on the door in the closed end position of said door. This defined assignment of signal transmitter and signal receiver makes it possible for the closed end position and/or the particular open position of the closing piston of the door to be detected and monitored in a reliable manner by the control device of the dishwasher. In particular, the determination device according to the invention is consequently largely insensitive to defective positions such as e.g. sloped positions or tilted positions of the door in relation to the inlet area of the loading opening.

In particular, it can be useful if the movably mounted element is embodied such that a tensioning force can be applied to it, by which it can be pushed from a released position to a closed position. In this way, an abrupt, sudden movement away from one another and/or movement toward one another of signal transmitter and signal receiver, in order to change the received signal level of the signal receiver largely independently of the closing movement or opening movement of the door in each case can be achieved in a simple design manner, which, when the door reaches a certain position, is characteristic of and/or specifically assignable to this position.

For applying a tensioning force, the movably mounted element can usefully be produced from a resilient material such as e.g. spring steel. In addition to or independently of this, the movably mounted element can, in particular for applying a tensioning force, be operatively connected to a resilient element, preferably a spring.

According to an advantageous development, the movably mounted element is mounted, in particular suspended or supported, such that it is linearly displaceable. This makes it possible for it to make a simple stroke movement to and fro, by means of which signal transmitter and signal receiver can be brought into different positions relative to one another in order to change in a selective manner the received signal level of the signal receiver. With the aid of this selective change, a defined position of the door, in particular the closed end position of said door, can be specifically characterized or marked, and detected by the control device of the dishwasher.

According to a further advantageous development of the invention, the movably mounted element is mounted in particular so as to enable it make a linear opening and closing stroke movement substantially orthogonally to an overlap zone which is formed between the washing compartment and the door in the region of the closed end position of said door. Since the door in its closed end position plunges into the front edge region of the washing compartment, in particular the front edge element or frame element of said washing compartment, this overlap zone can be used particularly advantageously as a reference plane, i.e. expressed in general terms as a reference for the linear movement of the movably mounted element. This linear opening and closing stroke movement can also be achieved in a simple design manner using simple components of a door lock. Said door lock can advantageously be embodied as a “snap-in lock”.

According to an advantageous development of the invention, the signal transmitter and the signal receiver of the determination device are assigned to the washing compartment and the door in particular such that, in the closed end position of the door, they lie, in particular along an imaginary connecting line largely flush, against one another. In this way, in the closed end position of the door, which position is to be detected, the signal transmitter and signal receiver advantageously face one another so closely that an adequately strong and perfectly detectable received signal can be generated by the signal receiver due to the opposing signal transmitter. In the closed end position of the door, the signal transmitter and the signal receiver preferably have the shortest distance or the shortest spacing of all the possible distances which lie between them during a closing or opening process of the door. In this way, constantly defined positional relationships are specified for the signal transmitter and the signal receiver in the closed end position of the door such that said closed end position can be detected in a reliable manner by the control device of the dishwasher on the basis of the received signal level generated in the signal receiver.

According to an advantageous development of the invention, the movably mounted element is in particular provided in and/or on the washing compartment and assigned a cavity, in particular a closing trough, in and/or on the door, in particular positionally corresponding in the closed end position of the door. The signal receiver can preferably be provided in and/or on the cavity and the signal transmitter in and/or on the free end, facing in the direction of the cavity, of the movably mounted element. Accommodating the signal receiver as a fixed component in and/or on the cavity of the door is particularly useful, as in this way the routing of one or more control and/or data lines between the signal receiver and the control device of the dishwasher can be embodied so as to be stationary, i.e. fixed and is thus simplified. It can be particularly useful if the signal transmitter is embodied as a passive component which can operate without electrical control lines and/or data lines from and to the control device of the dishwasher. In particular, a Hall sensor can be provided as the signal receiver and a magnet as the signal transmitter. These are available as reliable standard components.

Preferably, it can be useful if the internal contour of the cavity, in particular closing trough, is embodied so as to be substantially complementary to the external contour of the freely projecting end, assigned to the cavity, of the movably mounted element, in particular closing block. By this means, the retention of the freely projecting end, assigned to the cavity, of the movably mounted element, in particular closing block, in the cavity can be improved in the closed end position of the door. A unique position relative to one another in the closed end position of the door can thus be ensured in an improved manner between the movably mounted element, projecting freely in the direction of the cavity, with the signal transmitter, and the cavity with the signal receiver.

Alternatively, it is of course also possible to swap the positions of signal transmitter and signal receiver. It can optionally also be useful to switch, i.e. to swap, the positions of movably mounted element and cavity on and/or in the washing compartment and on and/or in the door.

According to an advantageous development of the invention, the contact surfaces of the movably mounted element and of the cavity are embodied and assigned to one another such that, when the door is moved from its closed end position to an open position, the movably mounted element and the cavity slide against one another with contact surfaces which are steeper than those contact surfaces of the movably mounted element and of the cavity which slide against one another when the door is moved in from an open position to its closed end position. This makes it possible to close the door and bring it to its closed end position using a relatively small pushing force (viewed in the depth direction), while a comparatively much greater pulling force or opening force has to be applied in order to move the door from its closed end position. Due to the fact that when moving the door from its closed end position to an open position the movably mounted element and cavity slide against one another with contact surfaces which are steeper than those contact surfaces of the movably mounted element and of the cavity which slide against one another when the door is moved in from an open position to its closed end position, it can be ensured in a quite simple design manner, in particular merely through appropriate surface design, that the door is positionally secured against unintentional opening in its closed end position by a sufficiently large retaining force or pressing force between the steeper contact surfaces of movably mounted element and cavity.

If the movably mounted element is affixed in and/or on the washing compartment and the associated cavity in and/or on the door, it may also in particular be useful if the cavity, in particular closing trough, has on its front wall edge nearer to the front of the door a shallower slope than on its rear wall edge further from the front of the door. Correspondingly, the free end of the movably mounted element then usefully has on its contact surface facing toward the interior of the washing compartment a steeper slope than on its contact surface facing away from the interior of the washing compartment.

It may in particular be useful if the movably mounted element with the signal transmitter, in particular a magnet, is provided for example in the central region of the upper front edge region of the washing compartment, and if a cavity, in particular a closing trough, having the signal receiver, in particular a Hall sensor, substantially positionally corresponding in the region of the upper edge and/or upper cheek section of the door, in particular the inner door frame of said door, is assigned to the movably mounted element. This central arrangement largely prevents inadmissibly high, in particular one-sided, mechanical stresses or even deformations of the door-lock housing with the movably mounted element, in particular signal transmitter of said element, of the cavity, in particular signal receiver of said cavity, of the washing compartment and/or of other components of the dishwasher from occurring when the door is opened and closed.

The following design variants, in particular, can be useful:

According to a particularly useful development of the invention, it can be provided in the inventive dishwasher that the movably mounted element can be subjected to a tensioning force , in particular spring pre-tensioning by means of a resilient spring element. The determination device according to the invention comprises a first and a second determination element. These can be formed by a signal transmitter and an assigned signal receiver. When the first determination element is brought close to the second determination element by means of a closing movement, in particular closing pivoted movement of the door, the tensioning force on the movably mounted element can initially be increased before the increased tensioning force abruptly moves the movably mounted element in the direction of the signal receiver. That is, the first determination element of the determination device, such as e.g. the signal transmitter of said determination device, said determination element being arranged on and/or in the movably mounted element, is, shortly before being brought close to the respective other, second element of the determination device, such as e.g. the signal receiver of said determination device, initially moved against a tensioning force away from the second determination element and then, due to the tensioning force, from a defined distance relative to the second determination element rapidly brought toward the second element. As a consequence, the signal receiver detects the signal transmitter only when said transmitter is arranged precisely in front of the signal receiver. The positions and/or locations of signal transmitter and signal receiver are of course also interchangeable here.

According to another useful development of the invention, it can be provided in the dishwasher that the movably mounted element is a closing piston of a door lock which is embodied so as to arrest the door. The device can particularly advantageously be part of a door lock which is embodied so as to arrest the door in a closed end position. In this way, in particular the signal transmitter or, if the positioning of the two determination elements is reversed optionally also the signal receiver, can be arranged in or on a movably mounted closing piston of a door lock. Combining the device with a door lock means that there is no need for two separate components, as a result of which the dishwasher can be of an even further simplified design.

A useful embodiment can in particular be a dishwasher in which the signal transmitter or the signal receiver of the device for determining the position of the door are arranged in and/or on the door, in particular the outer cheek or inner door of said door, and in and/or on the washing compartment, preferably the front edge region, in particular washing-compartment frame element, of said washing compartment, such that in a closed end position of the door they lie opposite one another, in particular flush-aligned. That is, one of the elements, the signal transmitter or the signal receiver, is arranged in and/or on the door, in particular the inner door of said door, and the other of the elements is arranged in and/or on the washing compartment, in particular the front upper edge region of said washing compartment. In this way, the signal transmitter and the signal receiver are guided toward one another when the door is closed. For example, the signal receiver can be seated in the wall material of the door, in particular the outer cheek or inner door of said door, preferably in the material forming the frame of the door or inner door. In this exemplary embodiment, the signal transmitter, corresponding to the signal receiver, can be arranged in and/or on a wall element of the washing compartment, in particular the front upper edge section of said washing compartment, or the washing-compartment frame element of said washing compartment, in particular on the side of the wall element facing toward the loading opening. The wall element can for example be a washing-compartment side wall, preferably the washing-compartment ceiling wall or the washing-compartment base tray. The same applies in cases where the washing compartment has a washing-compartment frame element or a washing-compartment edge element in the region of its front loading opening. Here, too, the wall element can be a ceiling wall, a side wall or a base wall of the washing-compartment frame element or washing-compartment edge element.

According to a particularly useful further development of the invention, it can be provided in the dishwasher according to the invention that the signal receiver is arranged in or on the base region of a cavity in the door, in particular an inner door of the door, and/or in or on the base region of a cavity in the washing compartment, in particular a washing-compartment frame element. The cavity serves inter alia as a guide for the movably mounted element, i.e. the movably mounted element is, in the closed end position of the door, pressed into the cavity due to the tensioning force acting upon said element. As a result, the movably mounted element with the signal transmitter can automatically be positioned correctly centered in front of the signal receiver provided in the base region. This ensures precise positioning of the signal transmitter and of the signal receiver relative to one another. The cavity constitutes an indentation in the door, the outer cheek or inner door of said door, or the washing compartment or the washing-compartment frame element. The cavity is preferably impressed into the outer cheek or frame of the door or inner door of the door or into the inside of the washing compartment, in particular the washing-compartment frame element. The position of signal transmitter and signal receiver are optionally also interchangeable such that the signal receiver is provided in and/or on the movably mounted element and the signal transmitter is assigned to the cavity.

According to a further useful development of the invention, it can be provided in the dishwasher according to the invention that the signal transmitter, or alternatively in a reversed arrangement the signal receiver, is arranged at a distance from the inner edge of the door, in particular the inner edge of the inner door of said door, in and/or on the door or the inner door, or that the signal transmitter, or alternatively in a reversed arrangement the signal receiver, is arranged at a distance from the outer edge of the washing compartment, in particular the washing-compartment frame element, in and/or on the washing compartment, in particular the washing-compartment frame element. This ensures that the device for determining the position of the door determines a closed end position of the door only when said door actually closes the loading opening of the washing compartment of the dishwasher.

According to a further particularly useful development of the invention, it can be provided in the dishwasher that (viewed in the depth direction of the door) a projection or a prominence is provided between the signal receiver arranged in and/or on door or inner door and the inner edge of the door, in particular the inner edge of the inner door. Alternatively or additionally, it can be useful if (viewed in the depth direction of the washing compartment) a projection or a prominence is provided between the signal transmitter arranged by means of the movably mounted element in and/or on the washing compartment, in particular the washing-compartment frame element and the outer edge of the washing compartment, in particular the washing-compartment frame element. The projection or the prominence displaces the movably mounted element, which is mounted in particular so as to be linearly displaceable during the closing of the door, and the signal transmitter arranged in or on the element away from the suitably complementary element, i.e. the signal receiver, shortly before the closed end position of the door is reached. This ensures that the signal transmitter and the signal receiver do not detect one another early and that a change of status of the door is not determined prematurely as a result. If the door is closed further, the movably mounted element, and thus the signal transmitter, is moved due to the tensioning force acting upon it abruptly in the direction of the complementary element, i.e. here the signal receiver, and positioned in front of said receiver. Consequently, a rapid transition to the closed end position or arrested position of the movably mounted element occurs. Such an embodiment of the dishwasher prevents the control device of the dishwasher from determining prematurely or incorrectly a closed end position of the door, even though such a position has not yet been reached. The projection or the prominence can preferably be arranged on the surrounding outer edge or outer cheek, in particular upper outer cheek, or the frame of the door or the inner door of said door and/or on the inside of the washing compartment facing toward the loading opening in the front edge region of said washing compartment or on the inside of the washing-compartment frame element or edge element of said washing compartment facing toward the loading opening. The projection or the prominence can be embodied such that, starting from the inner edge of the door or the inner door or from the outer edge of the washing compartment or the washing-compartment frame element, firstly a shallow rise and in the last area a steep fall is provided. This makes it possible that towards the end, the movably mounted element, which slides along the projection or the prominence, is guided abruptly in the direction of the corresponding element of the determination device, said element not being arranged in or on the movably mounted element. The above comments apply of course to cases in which the positions of signal transmitter and signal receiver and/or the positions of the movably mounted element and of the corresponding cavity are interchanged.

According to a further useful development of the invention, it can thus be provided in the dishwasher according to the invention that the projection or the prominence is formed by a region of the cheek or the frame of the door, in particular the inner door, said region being arranged between the inner edge of the door, in particular the inner door, and the cavity in the cheek or the frame of the door, in particular in the inner door. The movably mounted element, which is affixed in the door-lock housing on the washing compartment, is pushed back by the inner edge of the door, in particular the inner door, slides along the cheek or the frame of the door and is then pushed quickly into the cavity.

Alternatively or additionally, it can, according to another useful development of the invention, be provided in the dishwasher in which the cavity is assigned to the washing compartment that the projection or the prominence is formed by a region of the inside of the front edge region of the washing compartment facing toward the loading opening, in particular of the front edge element or washing-compartment frame element of said washing compartment, said element being arranged between the front outer edge of the washing compartment, in particular of the washing-compartment frame element, and the cavity in the washing compartment, in particular in any front washing-compartment edge element or washing-compartment frame element of said washing compartment which may be present. The same principle which was described previously applies here. The movably mounted element is pushed back by the outer edge of the washing compartment, in particular the edge element or washing-compartment frame element, slides along the inside and is then pushed quickly into the cavity.

According to a further particularly useful development of the invention, it can be provided in the dishwasher that the cavity is embodied for receiving the element or at least for receiving a free end of the element. The cavity can be embodied differently. The cavity or indentation is, however, in particular embodied such that it can receive at least the end of the movably mounted element, in particular an arresting end of the closing piston, preferably in a form-locking manner. The receiving of at least the free end of the movably mounted element, in particular the arresting end of the closing piston, in the cavity makes it possible for the door to be fixed or secured to the washing compartment or to the washing-compartment frame element.

According to a further particularly useful development of the invention, it can be provided in the dishwasher that the element for applying the tensioning force comprises a resilient material. Thus, the element can comprise an elastomer spring, for example a resilient foam material or a resilient rubber. An actuating force which is exerted on the door by an operator compresses the resilient material of the element such that, due to the compression, a tensioning force acts upon the element.

As an alternative to or in addition to an element, in particular a closing piston, which comprises a resilient material, it can according to a particularly useful development of the invention be provided in the dishwasher that the movably mounted element for applying the tensioning force is operatively connected to a resilient element, in particular a spring. The resilient element can, for example be a resilient foam material or a resilient rubber. The resilient element can preferably be a spring, in particular a compression spring. The spring can be embodied for example as a spiral-shaped compression spring, as a disc spring or as a pneumatic spring.

According to a particularly useful development of the invention, it can be provided in the dishwasher that the movably mounted element is arranged in a housing, in particular door-lock housing so as to be movable, in particular linearly displaceable. The movably mounted element, in particular closing piston, is preferably mounted in the housing so as to be linearly or longitudinally displaceable along a linear guide. The element can for example be affixed to a resilient element affixed to the housing. In this way, an end of the resilient element can be fastened to the housing and the other end of the resilient element can be fastened to the movably mounted element, in particular closing piston. It is not absolutely essential that the movably mounted element be affixed to the resilient element. The resilient element is preferably arranged in the housing such that it can exert a tensioning force on the movably mounted element. The movement of the movably mounted element is in this case limited by an additional limiting element which is preferably arranged in the housing or is formed by the housing itself, such that the movably mounted element is linearly or longitudinally displaceable along a defined path, but cannot fall out of the housing when the door is in the open position. When the movably mounted element strikes the limiting element, said limiting element is preferably in equilibrium, i.e. in a resting position.

According to a particularly useful development of the invention, it can be provided in the dishwasher according to the invention that the cavity is embodied in one piece, in particular as an integral component, with the outer cheek, in particular the upper check section, or the frame of the door, in particular the frame of the inner door of said door. This simplifies production of the cavity in the door, in particular the inner door. Subsequent installation of a cavity is not necessary. The cavity or indentation is particularly preferably impressed or stamped into the door or the inner door, in particular into the outer cheek of said door, in particular the frame of the door, preferably the inner door of said door.

Alternatively, it can be advantageous if a separate molded part containing the cavity is provided. The separate molded part is then usefully inserted into a corresponding recess in the outer cheek of the door, in particular the inner door of said door or frame of said door, and fastened there. The molded part can advantageously be produced with the internal contour of its cavity as required in each case, independently of the components of the door. In this way, the molded part can be given various outer and/or internal contours in a flexible manner. In particular, plastic or a metal material can be used for the molded part, which makes the production of said molded part simple and cheap.

According to a further useful development of the invention, it can be provided in the dishwasher according to the invention that a free end of the movably mounted element projects into the loading opening of the washing compartment when the door is open, due to the tensioning force acting upon the element. Where the movably mounted element is positioned on the door, a free end of this element usefully projects beyond the frame of the door when the door is open, due to the tensioning force acting upon the element. As a result, in both arrangement variants, the movably mounted element, in particular the movably mounted closing piston, is pushed back by the outer cheek, in particular inner edge of the door, in particular the inner door, or by the outer edge of the washing compartment, in particular the washing-compartment frame element, from its resting position against the tensioning force acting upon it, in particular linearly, such that, due to the increased tensioning force, at least the free end of the element, in particular arresting end of the closing piston, can then engage in the cavity. An advantage of such a positioning of the element or of the closing piston in its resting position is the simple arrangement of the cavity in and/or on the outer cheek, in particular the frame of the door or inner door, or alternatively in and/or on the inside of the washing compartment or of the washing-compartment frame element, enabled thereby.

According to a particularly useful development of the invention, it can be provided in the dishwasher that the door is arranged in a pivotably movable or displaceable manner on the dishwasher. A door that is arranged in a pivotably movable manner is in particular rotatably mounted in the lower region of the door. A door that is displaceably arranged on the dishwasher can be moved in and out like a drawer. In the moved-in state, such a sliding door closes the loading opening of the dishwasher, in particular a domestic dishwasher.

The movably mounted element or the housing can be fastened to the door or the inner door, or to the washing compartment or the washing-compartment frame element, in different ways. In particular, it is possible to use force-locked and/or bonded fastenings for this purpose. According to a further useful development of the invention, it can be provided in the dishwasher that the movably mounted element or the housing in which said element is arranged is fastened by means of latching or snap-in connections to the door or, in the case of alternative positioning, to the washing compartment.

The signal transmitter and the signal receiver can be designed in various ways. Thus, the signal transmitter can, for example, emit an optical signal which a correspondingly designed signal receiver can process. Alternatively, the signal transmitter can, for example, transmit an electrical or electromagnetic signal which a correspondingly designed signal receiver can process. According to a particularly useful development of the invention, it can be provided in the dishwasher that the signal transmitter comprises a magnet and the signal receiver a Hall sensor. The signal transmitter, i.e. in a preferred design variant the magnet, is preferably arranged in the movably mounted element and the signal receiver, in particular the Hall sensor, in the cavity. The arrangement of the signal transmitter in the movably mounted element makes it possible for the magnet, in particular, to be designed in a very simple manner.

As a result of the abrupt and directed guidance of the movably mounted element, said element and thus the signal transmitter, in particular magnet, mounted on and/or in it, is always located at the same distance from the correspondingly complementary element, i.e. the signal receiver, in and/or on the cavity. Alternatively, the positions of signal transmitter and signal receiver and/or the positions of the movably mounted element and the cavity can be swapped. In all arrangement variants, the closed end position of the door is detectable by the control device of the dishwasher in an improved manner because one element of the determination device is provided in and/or on the movable part, in particular closing piston, of the door lock. The movement of said door lock is largely independent of the closing and/or opening movement of the door.

The washing-compartment frame element or edge element, where present, advantageously forms the boundary of the loading opening of the washing compartment, i.e. the washing-compartment frame element or edge element preferably forms the front seal of the washing compartment facing toward the door.

The invention also relates to a door lock for a dishwasher, in particular domestic dishwasher, for closing the door of the washing compartment of said dishwasher, a determination device having a signal transmitter and a signal receiver being provided for determining the position of the door, characterized in that a movably mounted element is provided, in and/or on which the signal transmitter or the signal receiver of the determination device for determining the position of the door, in particular the closed end position of said door, is arranged.

Other embodiments and developments of the invention are reproduced in the subclaims.

The advantageous embodiments and developments of the invention explained hereinabove and/or in the subclaims may be used in the dishwasher according to the invention and the lock according to the invention individually or else in any combination with one another.

The invention, its embodiments and developments and the advantages thereof will be explained below with the aid of drawings, in which:

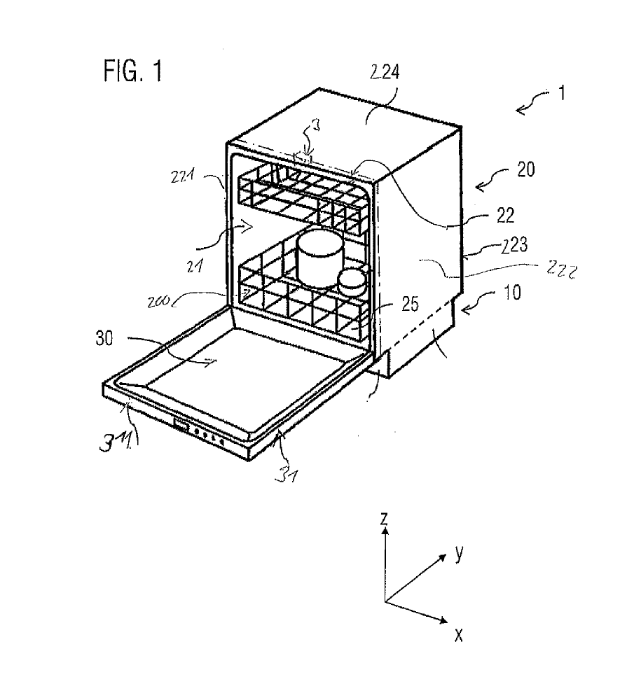

FIG. 1 shows schematically a perspective view of an advantageous exemplary embodiment of a dishwasher designed according to the invention comprising a door which is pivotably mounted in its lower region, for which door a closing device comprising a determination device for determining or establishing its position, in particular closed end position, is provided in accordance with the inventive design principle,

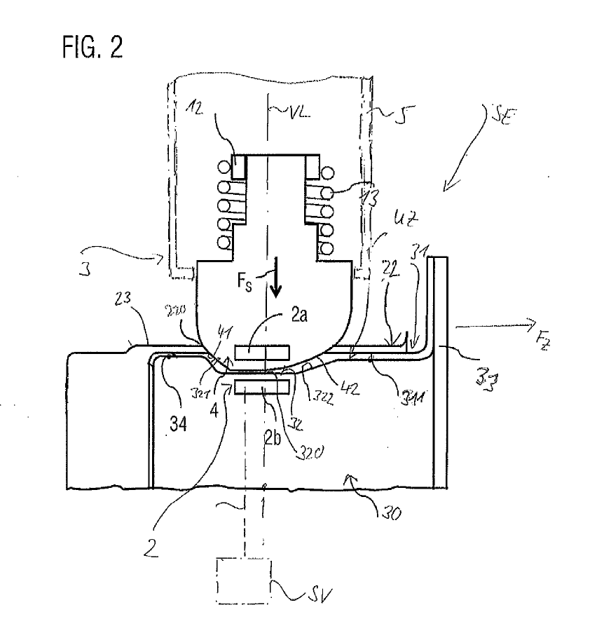

FIG. 2 shows schematically a lateral cross section of an advantageous exemplary embodiment of a closing device arranged on the dishwasher from FIG. 1 comprising a device for determining a position, in particular closed end position, of the door,

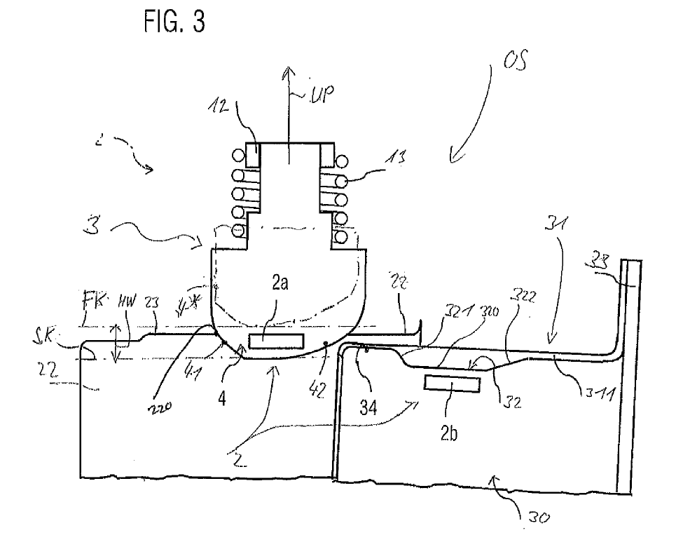

FIG. 3 shows schematically a lateral cross section of the closing device from FIG. 2 in an open position of the door,

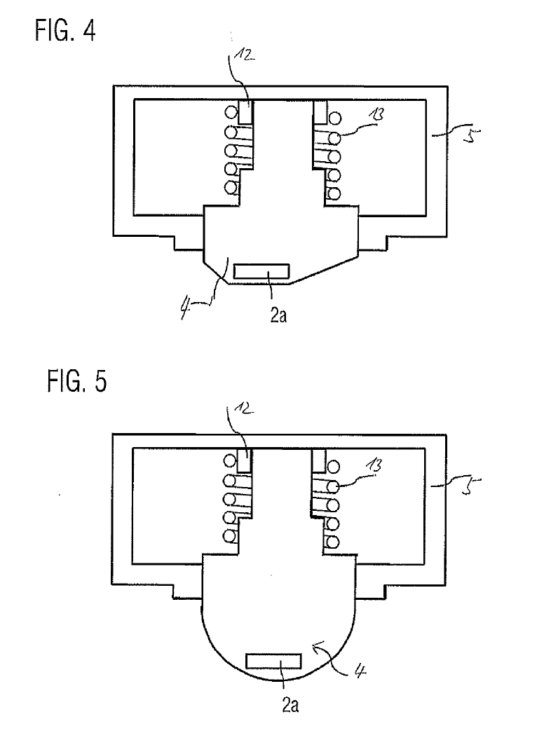

FIG. 4 shows schematically a lateral cross section of the movably mounted element, in particular closing piston, of the closing device according to the exemplary embodiment of FIGS. 2 and 3 arranged in a housing,

FIG. 5 shows schematically a lateral cross section of a movably mounted element, in particular closing piston, rounded in comparison with FIG. 4, in a housing,

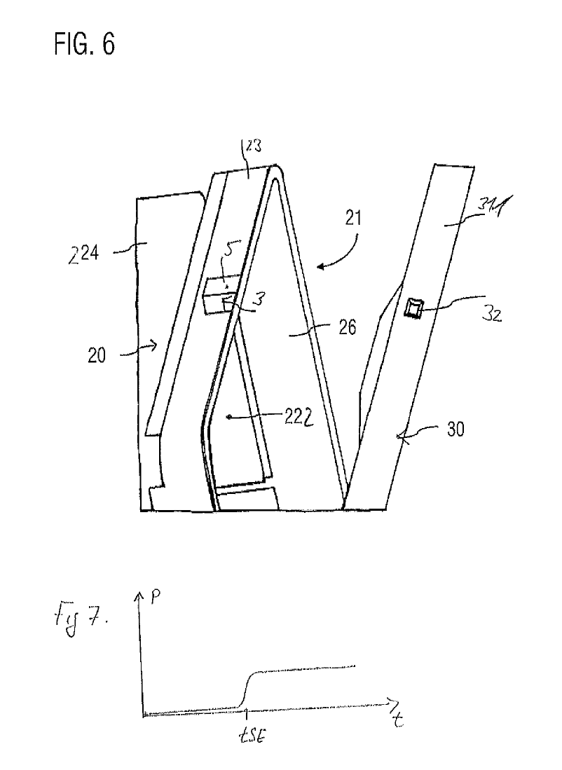

FIG. 6 shows schematically a perspective view of the loading opening of a modified washing compartment and of a door which is pivotably mounted on the washing compartment comprising a closing device which is designed in accordance with the inventive design principle of the closing devices from FIGS. 2 and 5, and

FIG. 7 shows schematically a reception level/time diagram of the signal receiver of the determination device of the dishwasher from FIG. 1 during closing of the door of said dishwasher.

Elements having the same function and mode of operation are labeled with the same reference characters in FIGS. 1 to 7 respectively.

FIG. 1 shows schematically in perspective representation an advantageous exemplary embodiment of a domestic dishwasher 1 which is designed in accordance with the inventive design principle. The domestic dishwasher 1 has a washing compartment 20 and a base module 10 arranged under said washing compartment. It can be designed, in particular, as a built-in appliance for installation in a niche e.g. of a kitchen line or a kitchen cabinet, as a table-top appliance or as a stand-alone appliance. The washing compartment 20 is composed of a vertically arranged washing-compartment back wall 223, which extends in the width and height direction x, z, two washing-compartment side walls 221, 222, arranged on the two side edges of the washing-compartment back wall 223, perpendicular thereto and extending toward the front in the height and depth direction z, y, as well as a washing-compartment ceiling wall 224 lying in the y, x plane and a base tray 25 arranged parallel thereto. In particular, the washing compartment 20 is assembled from a U-shaped washing-compartment hood, a back wall 223 arranged in a vertical plane x, z and a base tray 25 oriented in a horizontal plane x, y. The U-shaped washing-compartment hood is formed by a ceiling wall arranged in a horizontal plane x, y and two side walls 221, 222. These side walls are provided, in particular molded, on the longitudinal edges extending in depth direction y of the ceiling wall 224, i.e. laterally on the ceiling wall. Said side walls extend downward substantially perpendicularly to the ceiling wall 224. The washing compartment 20 is seated on the base module 10, i.e. the base module 10 is arranged, in the height direction or in the z direction of the x,y,z system of coordinates shown, below the washing compartment 20. The base module 10 provides the contact with a sub-base, in particular a floor, a workplate or a niche baseplate. The front loading opening 21 of the washing compartment 20 can be closed by the door 30. The door 30 is pivotably mounted on bearing pins which are provided on retaining devices of the base module 10 and/or of the lower region of the washing compartment 20 close to the washing compartment base. Said door comprises a front outer door 33 (see FIGS. 2, 3, 6) and an inner door 31 facing toward the loading opening 21, said inner door having a folded-over edge or external cheek.

The dishwasher 1, in particular domestic dishwasher, thus has a base module 10, also referred to as a base support, and a washing compartment 20 seated on the base module. The washing compartment can optionally additionally be surrounded externally by an outer housing, particularly if the dishwasher is designed as a stand-alone appliance or table-top appliance. In the case of a built-in dishwasher, such an outer housing is preferably omitted. The base module 10 is arranged under the washing compartment 20 and provides the contact with the respective installation location sub-base. The washing compartment has on its front side a loading opening 21 for loading the one or more dish racks 200 provided in the washing chamber of the washing compartment with washware to be cleaned. The front loading opening 21 of the washing compartment 20 can be closed by a door 30. The door 30 is pivotably mounted on bearing pins which are provided on retaining devices of the base module 10 and/or of the region of the washing compartment 20 close to the base tray. The loading opening 21 is thus opened for loading the one or more dish racks by means of a door 30 fastened to the dishwasher 1 and closed for operating the dishwasher by means of the door 30 fastened to the dishwasher 1. In domestic dishwashers, in particular, the loading opening is usually arranged on the front so that the door is usually fastened in the lower region of the washing compartment, in particular to the base module of the domestic dishwasher, either pivotably or alternatively retractably—like a drawer.

FIG. 2 shows schematically in a lateral cross section an advantageous exemplary embodiment of a determination device 2 arranged on a dishwasher 1 according to FIG. 1 for determining the positional status of the door, the door 30 being in a closed end position SE. The determination device 2 comprises a movably mounted element 3, here linearly displaceable in a linear guide 12. This element is formed by a closing piston or closing block of the door lock 3. The door-lock housing 5 (marked in FIG. 2 merely as a dot-dash line) of this door lock 3 is firmly affixed to the washing compartment 20 approximately in the central region of the front upper edge-region section 22 of the washing compartment 20. Said door-lock housing is positioned there relative to a through-opening 220 in the upper edge-region section 22 of the washing compartment 20 such that its movably mounted element 3 can be moved through an aperture opening 220 in a vertical direction z. In its arrested position SK, said movably mounted element protrudes with its free arresting end out of the aperture opening 220 inwardly into the loading opening 21 of the washing compartment 20. In a released position FK, said movably mounted element is retracted with its free end behind the aperture opening 220, viewed outwardly from the interior of the washing compartment, to the extent that the pivoting pathway for the door 30 is freed for the entry of said door into the loading opening 21. The arrested position SK and a released position FK of the free outer end of the movably mounted element 4 are each marked in FIG. 2 by a dot-dash line. The stroke pathway HW of the movably mounted element 4, which said element is minimally required to make in a vertically upward direction UP in order to render the loading opening 21 freely accessible, lies between the two positions FK, SK. In FIG. 2, the movably mounted element is additionally included in the drawing in a released position as a dot-dash line and labeled 4*. The movably mounted element 4 is subjected to a tensioning force Fₛ by a resilient element 13, here in the form of a spring, which pushes the movably mounted element 4 into the assigned cavity 32 which is provided in a positionally corresponding manner, in particular centrally, in the upper cheek section or frame section 311 of the inner door 31 of the dishwasher 1. The cavity 32 is embodied here as a trough or indentation in the upper section of the frame or the outer cheek of the inner door 31. In particular, the cavity 32 is impressed into the frame of the inner door 31 of the door 30. A separate molded part with a corresponding cavity can optionally also be inserted into a recess in the upper section of the inner door 31. The movably mounted element 4 or the free end 4 of the movably mounted element 4 engages, advantageously in a largely contour-fitting manner, in particular in a form-locking manner, with the cavity 32. The linear guide 12 for the movably mounted element 4 in the door-lock housing is embodied such that the element 4 is movable only in a vertical direction z.

The washing compartment 20 thus has a front washing-compartment edge region 22. This region is, viewed from the front, of a U-shaped design and runs along the front faces of the two side walls 221, 222 and the ceiling wall 224. On the front edge of the washing compartment, an additional edge element or washing-compartment frame element 26 (see FIG. 6) can optionally be provided only locally at selected points, only in sections or continuously along the entire length of said front edge. It can serve in particular to ensure adequate mechanical stability of the washing compartment 20 and/or to provide a sealing bed for a door 30. This front edge zone 22 of the washing compartment can optionally be designed for fastening the dishwasher 1 in an installation niche, in particular in a niche of a line of kitchen cabinets. The front washing-compartment edge region 22 can for this purpose preferably be of a rigid design. A door lock 3 (represented here in FIG. 1 only schematically) with an associated limiting device 6 is provided on the upper section 23 of the washing-compartment edge region 22, i.e. on the front edge section 23 (see FIG. 4), extending substantially in depth and width directions y, x, of the ceiling wall 224 of the washing compartment 20. FIG. 6 shows in perspective representation the door lock 3 on the upper exterior of the front washing-compartment edge region, which is formed by an edge element or washing-compartment frame element 26. This upper edge section 23 is arranged in the x,y plane approximately parallel to the ceiling wall 224. The door lock 3 is affixed externally approximately centrally to the upper section 23 of the washing-compartment edge region 22, in particular of any front edge element of the washing compartment or washing-compartment frame element 26 that may be present. Said door lock sits with its closing piston preferably on the upper washing-compartment edge region 23 which runs horizontally such that its closing piston can plunge through or pass through the aperture opening 220. Its closing piston projects out of the housing 5 of the door lock 3 through the aperture opening 220 (see FIG. 2) in the upper section of the front washing-compartment edge region 22 substantially vertically downward as a resiliently-mounted snap-in element, opposite to which a cavity or closing trough 32 is assigned on the upper side or upper edge of the cheek of the door 30, in particular of the door frame of said door, in particular of the door frame element (see FIG. 2). This upper edge section 23 is the front edge zone of the ceiling wall 224 of the washing compartment 20, which lies in a plane extending in depth direction y and width direction x. The cavity 32 has an internal contour which is designed so as to be substantially complementary to the external contour of the lower end of the closing piston. The closing trough may also be molded into the upper edge of the door cheek or door frame, in particular door frame element, by being impressed. Alternatively, it may optionally be formed by a molded part which is inserted as an independent component into a corresponding recess on the upper side of the door cheek, in particular the inner door, or the door frame, in particular door frame element, of said door. The respective cavity of this separate molded part can be produced with required internal contours in a simple manner in production engineering terms. Preferably, plastic or metal is chosen for this molded part comprising a closing trough, so different closing-trough forms can be produced simply, efficiently in production engineering terms and at low cost. In the closed end position of the door 30, the closing piston and the closing trough are oriented largely flush with one another. The front loading opening 21 of the washing compartment 20 can be closed by the door 30 by means of the door lock 3. In the closed end position SE of the door 30, the inner door of said door plunges partially or fully into the front washing-compartment edge 22 of the washing compartment 20 such that the inner door 31 and the washing compartment 20 cover one another, i.e. overlap, at least in a front edge zone or overlap zone UZ.

A signal transmitter 2a, in particular a magnet, is arranged in the movably mounted element 4 from FIG. 2. The movable element 4 is affixed in this design variant of the dishwasher 1 to the upper section 23 (see FIG. 6) of the front edge-region section 22 of the washing compartment. If the washing compartment 20 has a front washing-compartment edge element or washing-compartment frame element 26 (see FIG. 6), then the movable element can usefully be fastened accordingly thereto. A signal receiver 2b, in particular a Hall sensor, is fixedly arranged in the base region of the cavity 32.

FIG. 3 shows schematically in a lateral cross section the door lock 3 from FIG. 2 with the movably mounted element 4 which carries the signal transmitter 2a of the determination device 2, and the associated cavity 32 in the upper edge or the upper cheek of the door 30 in a state after the door 30 has been brought into an open position OS.

In the open position OS, the movably mounted element 4 is in a resting position, i.e. in equilibrium. In this resting position, the free end of the movably mounted element 4 preferably projects into the loading opening 21 of the washing compartment 20 of the dishwasher 1 such that when the door 30 is closed, the movably mounted element 4 is pushed back by the inner edge 34 of the inner door 31 and slides along the upper cheek section or frame section 311 of the inner door 31 until, due to the tensioning force which the resilient element 13 exerts on the movably mounted element 4 in a vertical direction z downward, the movably mounted element is pushed into the cavity 32 in the upper cheek section or frame section 311 of the inner door 31 in the closed end position SE of the door 30, as a result of which the movably mounted element 4 assumes its locked position SK (see FIG. 2) in the specifically assigned cavity 32, in particular positionally corresponding on the door 30. During the closing process, the resilient element 13 is initially compressed, as a result of which the tensioning force Fₛ of the resilient element 13 is increased. The tensioning force of the resilient element 13 is directed in the direction of the free end 4 of the movably mounted element 4. The contour of the free end 4 of the movably mounted element 4 is designed such that when the door 30 is closed the front 42 of the free end 4 of the element 4, which front strikes the inner edge 34 of the inner door 31, is of a shallower design than the other side, i.e. the back or rear side 41 of the free end of the element 4. That is, the front 42 of the free end 4 of the element 4, which front, when the door 30 is closed, initially strikes the inner edge 34 of the inner door 31, in particular a tangent which is drawn to the contour of this front 42 of the free end of the element 4, has a greater angle to the vertical longitudinal axis z of the linear guide 12 than the subsequent second side or back or rear side 41 of the free end of the element 4. This specific design of the free end of the movably mounted element 4 makes it easier to close the door 30 than to open it. When it is closed, the free end of the element 4 slides with its shallow slope or ramp 42 easily along the inner edge 34 of the inner door 31. The frictional force occurring can be overcome relatively easily. The steeper second slope or ramp 41 of the movably mounted element 4 ensures firstly that the movably mounted element 4 plunges quickly into the cavity 32 when the movably mounted element 4 reaches the cavity 32, and secondly that said element is held securely in the cavity 32. The steeper second slope 41 of the free end of the movably mounted element 4 which in the closed end position is directed toward the inner edge 34 of the inner door 31, see FIG. 2, abuts (when viewed into the washing compartment) against the rear wall slope 321 of the cavity 32. When the door 30 is opened, it is necessary, due to the great steepness of the steep second slope 41 of the free end of the element 4 or of the wall of the cavity, to apply a greater force in order to be able to overcome the frictional force between the second, steep slope 41 of the free end of the element 4 and the lower steep wall 321 of the cavity 32 as well as the tensioning force Fₛ of the resilient element 13.

In the design variant of the dishwasher 1 shown in FIGS. 2 and 3, the signal transmitter 2a, in particular in the form of a magnet, is arranged in the movably mounted element 4, in particular embedded in the material of the free end of the element 4. The signal receiver 2b, in particular a Hall sensor, is arranged close to the base region or bottom 320 of the cavity 32 in the inner door 31 of the door 30. Due to the fact that, when the door 30 is closed, the movably mounted element 4 and thus the signal transmitter 2a is initially pushed back in the direction of the linear guide 12 vertically upward by the inner edge 34 and the region of the upper cheek section or frame section 311 of the inner door 31, which region is arranged between the inner edge 34 of the inner door 31 and the cavity 32 and forms a prominence relative to the cavity or trough 32, the signal transmitter 2a is, during the last part of the closing process of the door, initially intentionally moved vertically upwards away from the signal receiver 2b. The tensioning force Fₛ of the resilient element 13 in increased in comparison to its unloaded state when the door is open. Only in the final moment of the closing movement of the door, once the movably mounted element 4 has reached the cavity, is this element abruptly pushed by the pre-tensioned force or elasticity of the resilient element 13 into the cavity 32. By this means, the movably mounted element 4 plunges quickly into the cavity 32. There it is retained under vertically downward spring tension or spring force firmly in the cavity 32 with a defined retaining force. Due to the movement of the signal transmitter 2a away from the signal receiver 2b in or below the base 320, in particular the lowest point of the cavity 32, generating a pre-tensioning force for the movably mounted element 4 by virtue of an upward stroke process before the closed end position of the door is reached, the signal transmitter 2a does not approach the signal receiver 2b continuously, but an abrupt rapid approach occurs only in the final moment of the door closing movement, i.e. only in the closed end position of the door. This leads to a rapid increase in magnetic field strength at the signal receiver 2b. If a Hall sensor is used, then the increase in the strength of the magnetic field is accompanied by a sudden rise in the reception level or output level thereof, in particular output voltage thereof. This can be analyzed by the control device SV of the dishwasher 1. The control device SV is to this end connected via at least one control line and/or data line SL to the signal receiver 2b of the determination device. The control device SV and the signal line SL are drawn in FIG. 2 as dot-dash lines. A dishwasher 1 of such a design enables a very accurate display of the closed end position of the door 30 on the washing compartment 20 of the dishwasher 1. In particular, the moving of the movably mounted element 4 away from the cavity 32 in a closure preparation step before the closed end position of the door is reached and the subsequent rapid plunging of the movably mounted element 4 into the cavity 32 when the closed end position of the door is subsequently reached makes it possible for the closed end position of said door to be very precisely defined such that the determination device 2 for determining the position of the door 30 does not display the closed end position of the door 30 until this position has actually be reached. The plunging of at least the free end of the movably mounted element 4 and thus of the signal transmitter 2a into the cavity 32 makes it possible for the signal transmitter 2a to be arranged directly in front of the signal receiver 2b which is arranged close to the base region 320 of the cavity 32. If the free end of the movably mounted element 4 does not for some reason snap into the cavity 32 during the end of the door closing process, for example due to a slight twisting or tilting of the door 30 in relation to the loading opening 21 of the washing compartment 20, then no closed end position of the door 30 is determined, and the dishwasher 1 is consequently not started by the control device SV, in particular a selected dishwashing program is not started. The control device SV may be accommodated e.g. in the interior of the door 30. In particular, the control device SV is designed such that a selected dishwashing program is started only when the closed end position SE of the door 30 has been detected or determined by the control device SV.

The door lock 3 with the movably mounted element 4, in particular closing piston, is usefully affixed to the upper edge section 23 of the front washing-compartment edge region 22, in particular in the central region thereof, such that the closing piston is able in its released position to move substantially vertically upwards and/or downwards. When, for example, the door 30 is closed, then the inner door 31 or door frame of said door 30 presses, starting from a defined closed position or arrested position during the closing movement of the pivotably movable door, from below onto the closing piston and presses this piston into the housing 5 of the door lock 3. In the process, the resilient element 13, in particular a spiral spring, in the housing of the door lock 3 is compressed and pre-tensioned. As soon as the door approaches during its closing movement its closed end position and the cavity 32, in particular closing trough, in the door, in particular inner door or door frame 31, lies opposite the closing piston 4, preferably largely congruent to the upper edge section of the inner door or door frame, the closing piston is pressed, due to the pre-tensioning force or spring force Fₛ of the resilient element 13 in the housing 5 of the door lock 3, downward, in particular vertically downward, into the internal contour of the cavity, in particular closing trough, which is preferably adapted to match the external contour of the closing piston, such that it abuts against the internal contour of the closing trough in a form-matched manner and is firmly held there with a defined retaining force or closing force. The closing piston sits in particular in a largely tight-fitting or form-locking manner in the closing trough. A pull-open lock or snap-in lock is consequently formed in which the door can be pulled from its closed end position into an open position only when this vertically acting closing force Fₛ is overcome through the application of a correspondingly large tensile force F_{z} on the door. A reliable safeguard, in particular a child protection device, against unintentional opening of the door is provided by this means.

In particular, it is useful if, in the closed end position of the door 30, the closing trough 32 has, viewed from the front, a rear slope or edge 321 which is steeper than its front slope or edge 322. Correspondingly, the movably mounted element 4, in particular the closing piston, usefully has at its lower end a rear slope or edge 41 which substantially corresponds to the steepness of the rear slope or edge 321, in particular steep wall of the closing trough 32, as well as a front slope or edge 42 which substantially corresponds to the steepness of the front slope or shallow edge 322, in particular shallow wall of the closing trough 32. The closing trough is thus embodied with a shallower edge or slope on the front than at its rear. This is shown schematically in the side views in FIG. 2 and FIG. 3 respectively. As a result, the front slope surfaces of the closing piston and the closing trough slide smoothly against one another when the door is closed a small horizontal pushing force component is applied, whereas by comparison, when the door is opened or pulled out of its closed end position, a larger minimum tensile force F_{z} (forward in the y direction) is required. For the rear adjacently lying edges of closing piston and closing trough to slide against one another and thus for the closing piston to be pressed back into a released position in the door-lock housing, a greater tensile force is required in a horizontal direction, to the extent that against the vertically downwardly directed spring pre-tensioning force Fₛ of the spring element 13 of the door lock, a vertically upwardly directed force component can be produced (by the door being moved forward away from the loading opening) which is greater than this spring pre-tensioning force of the spring element. The greater the steepness of the adjacently lying rear edges of closing piston and closing trough, the greater the force holding them against one another when a forwardly directed horizontal opening movement of the door occurs and the greater is the tensile force or opening force F_{z} that has to be exerted in order to open the door.

FIGS. 4 and 5 each show schematically in lateral cross section different advantageous embodiments of a movably mounted element 4 in the door-lock housing 5 for the inventive closing device of the dishwasher 1 from FIG. 1. The element 4 is linearly or longitudinally, in particular in the vertical direction z, displaceably mounted in the linear guide 12. The resilient element 13 exerts a tensioning force Fₛ on the element 4 in a downward direction. The tensioning force is thus in the closed end position of the door 30 directed in the direction of the cavity 32. The movability/displaceability of the element 4 can be limited by a limiting element (not shown). Alternatively, the element 4 can be fastened to one end of the resilient element 13. The resilient element 13 is then advantageously fastened with its other end to the housing 5. The linear guide 12 is preferably mounted on the inside of the housing 5. The end of the element 4 has a signal transmitter 2a embedded in the element 4. In FIG. 4, the free, downwardly projecting end of the element 4 is embodied with an angular outer edge. In FIG. 5, the end of the element 4 is embodied with a rounded external contour, in particular semi-circularly. The cavity into which at least the free end 4 of the movably mounted element 4 plunges is advantageously embodied such that the free end of the element 4 can plunge into said cavity in a largely contour-fitting manner, in particular in a form-locking manner. A frontal front region of the free end 4 of the movably mounted element 4 is preferably embodied so as to be shallower than the rounded region of the door 30, so that the closing of the door can be effected more easily, i.e. can be effected with a compressive force which is less than the tensile force F_{z} (see FIG. 2) that has to be applied in order to open the door and which force is directed substantially tangentially to the overlap zone UP which is formed in the closed end position SE of the door between the upper section 23 of the front washing-compartment edge section 22 and the upper cheek section 311 of the inner door 31.

FIG. 6 shows schematically a perspective view of the front loading opening 21 of the washing compartment 20 and of the door 30 which is pivotably mounted on the washing compartment 20 and/or the base module 10 of said washing compartment of the dishwasher from FIG. 1. The washing compartment 20 now has in amendment to the design variant of FIGS. 1 to 5 an additional front edge element or washing-compartment frame element 26 which supplements frontally the side walls 221, 222 and the ceiling wall 224 of the washing compartment in the various planes thereof. The door-lock housing 5 which surrounds the movably mounted element 4 is arranged, in particular fastened, on the edge element or washing-compartment frame element 26 of the washing compartment 20. The housing 5 is arranged in particular such that the element 4 in its resting position projects with its downwardly freely projecting end into the loading opening 21 of the washing compartment 20. The cavity 32 is provided in the central region of the upper cheek section or edge section 331 or frame of the inner door 31 of the door 30. The cavity 32 is arranged in the upper cheek section or edge section 331 or frame of the inner door 31 of the door such that, in a closed end position SE of the door 30, at least the downwardly freely projecting end of the element 4 can engage in the cavity 32, in particular in a form-locking manner, due to the tensioning force Fₛ acting upon it. The cavity 32 is preferably embodied in one piece with the upper cheek section or edge section 331 or frame of the door 30. The cavity can be created during the production process monolithically with the frame of the door 30 or subsequently impressed or stamped into the frame of the door 30.

As an alternative to the pivotable mounting of the door 30 on the dishwasher 1, the door 30 can also be slidably arranged, in particular in the depth direction of the washing compartment of said dishwasher 1, in the manner of a drawer on the dishwasher 1.

FIG. 7 illustrates schematically the time curve of the reception level or output level P of the signal receiver 2b as a function of time t during the closing of the door. Since the signal transmitter 2a and the signal receiver 2b are movably arranged relative to one another on the movably mounted element 4 of the washing compartment 20 and the door 30 such that the signal transmitter 2a and the signal receiver 2b are initially moved away from one another during the closing of the door 30 before the closed end position SE of said door is reached and are moved toward one another only in the region of the closed end position SE of the door 30, the level P rises abruptly and steeply only at time tSE which is assigned to the reaching of the closed end position SE, while in the period before that no detectable level value is output from the signal receiver 2b to the control device SV. Errors in the detection of the closed end position of the door by the control device SV are consequently largely avoided.

In summary, a dishwasher, in particular domestic dishwasher, is consequently provided with a closing device for the door of said dishwasher, which closing device has frontally on the washing compartment, in particular on the front washing-compartment frame element of said washing compartment, a closing piston in a mounting device such that the closing piston is pressed under spring pre-tension into a linear or longitudinal stroke movement in the direction of a cavity assigned to said closing piston in and/or on the door, in particular door frame. If the mounting device with the closing piston is firmly affixed in the region, in particular central region, of the upper edge section of the ceiling wall of the washing compartment and the cavity is provided positionally correspondingly in the edge of the upper door cheek section or door frame, in particular in the central region thereof, then, in the closed end position of the door, the closing piston of the closing device is pressed, due to the taking effect of the spring pre-tension of a spring element of the mounting device, in the form of a vertical stroke movement downward into the cavity, in particular closing trough, and positionally secured there. To this end, the cavity has an inner contour which is embodied so as to be substantially complementary to the external contour of the closing piston. When the door is pulled open, in contrast, the closing piston is pressed back under spring pre-tension vertically upwardly as it is extracted from the cavity and pulled along the door frame, so that the loading opening of the washing compartment is released for the door to be moved out. Once the door is open to the extent that the upper door cheek section or door frame section is located outside the washing compartment, in particular washing-compartment frame element, the closing piston snaps downwardly out of its retaining device and remains in a pressed-out position free of any counterforce loading.

Particularly if the internal contour of the cavity is embodied so as to be largely complementary to the external contour of the free end of the closing piston, closing piston and the cavity center themselves relative to one another automatically in the closed end position of the door such that the signal transmitter in the closing piston and the signal receiver in the cavity lie opposite one another along a line of alignment VL (see FIG. 2) when the closed end position of the door is reached.

During the closing of the door, the closing piston of the retaining device, which (when viewed in the depth direction y) is affixed to said washing compartment inwardly offset in relation to a front edge zone, in particular ceiling-wall edge zone of the washing compartment, abuts the inner edge zone or cheek of the door facing it and as a result, generating a spring pre-tension of its resilient element, is pressed away from the door by a linear or longitudinal stroke movement, in particularly vertically upwardly. When, during the closing process, the door enters the region of the cavity which (viewed in the depth direction) is provided offset to the inner edge of the inner door of the door facing toward the washing compartment, then the closing piston jumps, due to the spring pre-tension of its resilient element, out of the retaining device into the cavity by means of a linear or longitudinal stroke movement, in particular vertical stroke movement downwards, such that an arresting or latching occurs there between closing piston and cavity. This linear stroke movement of signal transmitter and signal receiver relative to one another in the region of the closed end position of the door ensures that the closed end position of the door can always be unambiguously detected by the signal receiver. This linear stroke movement of the closing piston with the signal transmitter largely prevents the signal transmitter from coming to lie, in the closed end position of the door, so far laterally offset relative to the signal receiver in the cavity that the signal receiver can no longer detect the signal transmitter adequately, if at all. The linear stroke movement of the closing piston with the signal transmitter ensures instead that, in the closed end position of the door, said signal transmitter is always aligned largely flush with the signal receiver in the trough, i.e. there is always a defined end position of the signal transmitter relative to the signal receiver in the closed end position of the door. In this way, unambiguous detection of the closed end position of the door is always possible even where the door, on account e.g. of production tolerances or wear in the width direction and/or height direction of the washing compartment, makes offset movements.

Alternatively, the position of the closing device and associated cavity can be swapped, i.e. the closing device is then affixed to the door, while the cavity is provided on the washing compartment.

Optionally, the position or location of signal transmitter and signal receiver can, if necessary, also be swapped. However, the affixing of the signal receiver in the region of the stationary cavity is more advantageous, as the running of the signal line to the control device of the dishwasher can then be of a stationary, i.e. immovable, design.

### LIST OF REFERENCE CHARACTERS

1 dishwasher
2 determination device for determining the position, in particular closed end position, of a door
2a signal transmitter
2b signal receiver
3 door lock
4, 4* movably mounted element
41 steep contact surface
42 shallow contact surface
5 door-lock housing
7 housing of the closing piston
10 base module
12 linear guide
13 resilient element
20 washing compartment
21 front loading opening
200 dish racks
220 through-opening in the front washing-compartment edge region
221, 222 washing-compartment side walls
223 washing-compartment back wall
224 washing-compartment ceiling wall
22 front edge region of the washing compartment
23 upper edge zone section of the washing compartment
25 base tray
26 front washing-compartment frame or washing-compartment edge element
30 door
31 inner door
311 upper cheek of the inner door
32 cavity
320 bottom of the cavity
321 steep wall of the cavity
322 shallow wall of the cavity
34 inner edge of the inner door or projection/prominence on the cheek of the door
Fₛ tensioning force
F_{z} tensile force
SE closed end position of the door
OS open position of the door
FK released position of the movably mounted element
SK locked position of the movably mounted element
VL line of alignment
HW stroke pathway
UP upward movement of the movably mounted element
UZ overlap zone
P level of the signal receiver
t time
tSE time at which the closed end position of the door is reached

1-17. (canceled)

18. A dishwasher, comprising:
a washing compartment having a loading opening;
a door to close the loading opening;
a determination device for determining a position of the door, said determination device comprising a signal transmitter and a signal receiver; and
a movably mounted element,
wherein a member selected from the group consisting of the signal transmitter and the signal receiver is arranged in and/or on the movably mounted element for determining the position of the door.

19. The dishwasher of claim 18, constructed in the form of a domestic dishwasher

20. The dishwasher of claim 18, wherein the member is provided to determine a closed end position of the door.

21. The dishwasher of claim 18, wherein the movably mounted element is designed as a closing piston or closing block of a door lock.

22. The dishwasher of claim 18, wherein the movably mounted element is designed so as to be subjectable to a tensioning force, by which the movably mounted element is movable from a released position to a closed position.

23. The dishwasher of claim 18, wherein the movably mounted element is mounted for displacement in a linear manner.

24. The dishwasher of claim 18, wherein the movably mounted element is suspended or supported.

25. The dishwasher of claim 23, wherein the movably mounted element is mounted so as to enable the movably mounted element to execute linear opening and closing stroke movements substantially orthogonally to an overlap zone which is formed between the washing compartment and the door in a region of a closed end position of the door.

26. The dishwasher of claim 18, wherein the movably mounted element is provided in or on the washing compartment, or in or on the door.

27. The dishwasher of claim 18, wherein the signal transmitter and the signal receiver of the determination device are assigned to the washing compartment and the door such that, in a closed end position of the door, the signal transmitter and signal receiver lie largely flush against one another.

28. The dishwasher of claim 27, wherein the signal transmitter and signal receiver lie largely flush against one another along an imaginary connecting line.

29. The dishwasher of claim 18, wherein a member selected from the group consisting of the washing compartment and the door has a cavity assigned to the movably mounted element.

30. The dishwasher of claim 29, wherein the cavity is configured as a closing trough.

31. The dishwasher of claim 29, wherein the cavity is configured positionally corresponding to the movably mounted element in a closed end position of the door.

32. The dishwasher of claim 29, wherein the cavity has an internal contour which substantially complements to an external contour of a freely projecting end of the movably mounted element.

33. The dishwasher of claim 29, wherein the signal transmitter is provided in or on the movably mounted element and the signal receiver is provided in or on a base region of the cavity.

34. The dishwasher of claim 29, wherein the signal transmitter is provided in or on a base region of the cavity and the signal receiver is provided in or on the movably mounted element.

35. The dishwasher of claim 29, wherein the movably mounted element and the cavity have first and second contact surfaces embodied and assigned to one another such that, when the door is moved from a closed end position to an open position, the movably mounted element and the cavity slide against one another with the first contact surfaces which are steeper than the second contact surfaces of the movably mounted element and of the cavity which second contact surfaces slide against one another when the door is moved inward from the open position to the closed end position.

36. The dishwasher of claim 18, wherein the signal transmitter and the signal receiver are arranged movably relative to one another on the movably mounted element and the door such that the signal transmitter and the signal receiver are initially movable away from one another, before the door reaches a closed end position during a closing of the door, and are movable toward one another only in a region of the closed end position of the door.

37. The dishwasher of claim 18, wherein the movably mounted element is provided with the signal transmitter approximately in a central region of an upper front edge region of the washing compartment, and wherein a cavity having the signal receiver is assigned to the movably mounted element substantially positionally corresponding in a region of an upper edge of the door.

38. The dishwasher of claim 18, wherein the signal transmitter includes a magnet.

39. The dishwasher of claim 37, wherein the cavity is configured as a closing trough.

40. The dishwasher of claim 37, wherein the signal receiver is a Hall sensor.

41. The dishwasher of claim 37, wherein the cavity with the signal receiver is placed in an inner door frame of the door.

42. The dishwasher of claim 37, wherein the cavity has a front wall edge and a rear wall edge, with the front wall edge being positioned nearer to a front of the door than the rear wall edge, said front wall edge having a slope with is shallower than a slope of the rear wall edge.

43. The dishwasher of claim 37, wherein the movably mounted element has a free end with a first contact surface facing toward an interior of the washing compartment and a second contact surface facing away from the interior of the washing compartment, said first contact surface having a slope which is steeper than a slope of the second contact surface.

44. A door lock for closing a door of a washing compartment of a dishwasher, said door lock comprising a movably mounted element for attachment of a signal transmitter or a signal receiver of a determination device for determining a position of the door.

45. The door lock of claim 44 for use in a domestic dishwasher.

46. The door lock of claim 44, wherein the position is a closed end position of said door.

47. The door lock of claim 44, wherein the movably mounted element is designed as a closing piston or closing block of the door lock.

48. The door lock of claim 44, wherein the movably mounted element is designed so as to be subjectable to a tensioning force, by which the movably mounted element is movable from a released position to a closed position.

49. The door lock of claim 44, wherein the movably mounted element is mounted for displacement in a linear manner.

50. The door lock of claim 44, wherein the movably mounted element is suspended or supported.

51. The door lock of claim 46, wherein the movably mounted element is mounted so as to enable the movably mounted element to execute linear opening and closing stroke movements substantially orthogonally to an overlap zone which is formed between the washing compartment and the door in a region of the closed end position of the door.

52. The door lock of claim 44, wherein the movably mounted element is provided in or on the washing compartment, or in or on the door.

53. The door lock of claim 44, wherein the movably mounted element interacts with a cavity of the washing compartment or the door.

54. The door lock of claim 53, wherein the movably mounted element is configured positionally corresponding to the cavity t in a closed end position of the door.

55. The door lock of claim 53, wherein the movably mounted element has a freely projecting end with an external contour which substantially complements an internal contour of the cavity.

56. The door lock of claim 53, wherein the movably mounted element is configured for attachment of the signal receiver, with the signal transmitter provided in or on a base region of the cavity.

57. The door lock of claim 53, wherein the movably mounted element and the cavity have first and second contact surfaces embodied and assigned to one another such that, when the door is moved from a closed end position to an open position, the movably mounted element and the cavity slide against one another with the first contact surfaces which are steeper than the second contact surfaces of the movably mounted element and of the cavity which slide against one another when the door is moved inward from the open position to the closed end position.

58. The door lock of claim 53, wherein the movably mounted element is provided with the signal transmitter approximately in a central region of an upper front edge region of the washing compartment, wherein the cavity with the signal receiver is assigned to the movably mounted element substantially positionally corresponding in a region of an upper edge of the door.

59. The door lock of claim 44, wherein the movably mounted element has a free end with a first contact surface facing toward an interior of the washing compartment and a second contact surface facing away from the interior of the washing compartment, said first contact surface having a slope which is steeper than a slope of the second contact surface.
